(19) United States
(12) Patent Application Publication
(10) Pub. No.: US 2005/0238934 A1
(43) Pub. Date: Oct. 27, 2005

(54) Fuel cell stack defrosting

(76) Inventor: Naoki Takahashi, Kanagawa (JP)

Correspondence Address: MCDERMOTT WILL & EMERY LLP, 600 13TH STREET, N.W., WASHINGTON, DC, 20005-3096, US

(21) Appl. No.: 10/518,584

(22) PCT Filed: Jun. 9, 2003
(86) PCT No.: PCT/JP03/07256

§ 371 Date: Dec. 21, 2004

(30) Foreign Application Priority Data
Jun. 26, 2002 (JP) 2002-185889

(51) Int. Cl. H01M 8/04

(52) U.S. Cl. 429/24; 429/23; 429/13

(57) ABSTRACT

A fuel cell power plant comprises a fuel cell stack (1) constituted by a plurality of fuel cells which perform electric power generation by means of a reaction of hydrogen and oxygen. A controller (16) determines whether or not moisture inside the fuel cell stack (1) is frozen, and if the moisture is frozen, the controller (16) causes the fuel cell stack (1) to perform intermittent electric power generation via an inverter (27) while continuing to supply oxygen to the fuel cell stack (1). The fuel cell stack (1) generates heat as a result of the electric power generation, whereby moisture is generated in a cathode (9). During the periods in which electric power generation is not performed, the oxygen which is supplied to the cathode (9) of the fuel cells scavenges the generated moisture, thereby ensuring the supply of oxygen to the cathode (9) during electric power generation.

### FIELD OF THE INVENTION

This invention relates to the defrosting of ice in the interior of a fuel cell stack when the fuel cell stack is operated below freezing point.

### BACKGROUND OF THE INVENTION

Water exists in various locations in a polymer electrolyte fuel cell (PEFC). During operations of the fuel cell, for example, a polymer electrolyte membrane is maintained in a damp state. Moreover, pure water is generated in the cathode of the fuel cell during electric power generation. Further, since the fuel cell generates heat during electric power generation, a cooling water passage is formed in the fuel cell. Hence when the fuel cell is placed in below freezing conditions for a long period of time, the moisture in the interior thereof freezes. In order to operate the fuel cell in this state, first the interior ice must be defrosted.

JP2000-315514A, published by the Japanese Patent Office in 2000, proposes the use of high temperature fluid heated using the electric power of a secondary battery to defrost the moisture inside a fuel cell.

JP2000-512068A, published by the Japanese Patent Office in 2000, proposes that electric power generation in the fuel cell be started in a frozen state such that the ice in the interior of the fuel cell is defrosted by the heat generated during power generation.

### SUMMARY OF THE INVENTION

A power plant according to JP2000-315514A is dependent upon the secondary battery for all types of driving energy such as heating energy and energy required for recirculating high temperature fluid to the fuel cell. As a result, the load on the secondary battery is large and thus a large-size secondary battery is necessary.

In the power plant according to JP2000-512068A, when power generation is performed in the fuel cell with all of the interior moisture frozen, water vapor which is generated in the cathode is cooled rapidly due to heat exchange with peripheral members, thereby condensing to form water or ice. This water or ice blocks the gas passage and gas diffusion layer of the cathode, thereby obstructing the supply of air to the cathode. In this state the power generation reaction is insufficient and the amount of generated heat is small, and thus a large amount of time is required for the ice to defrost completely such that the fuel cell can be operated normally. In order to prevent blockages in the gas passage and gas diffusion layer, power generation must be performed at a low power current value, but in so doing the amount of heat generated by the power generation reaction is small, and thus defrosting still requires a large amount of time.

It is therefore an object of this invention to shorten the start-up time of a fuel cell stack in a frozen state without expending the electrical power of a secondary battery.

In order to achieve the above object, this invention provides a fuel cell power plant comprising a fuel cell stack comprising fuel cells which generate electric power under a supply of hydrogen and oxygen, a mechanism which supplies oxygen to the fuel cell stack, a sensor which detects a parameter for determining if moisture in the fuel cell stack is frozen, and a controller.

The controller functions to determine if the moisture in the fuel cell stack is frozen based on the parameter, and cause the fuel cell stack to perform intermittent electric power generation when the moisture in the fuel cell stack is frozen.

This invention also provides a control method of such a fuel cell power plant that comprises a fuel cell stack comprising fuel cells which generate electric power under a supply of hydrogen and oxygen and a mechanism which supplies oxygen to the fuel cell stack. The method comprises detecting a parameter for determining if moisture in the fuel cell stack is frozen, determining if moisture in the fuel cell stack is frozen based on the parameter, and causing the fuel cell stack to perform an intermittent generation of electric power when the moisture in the fuel cell stack is frozen.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel cell power plant according to this invention.

FIG. 2 is a flowchart describing a routine for defrosting a fuel cell stack performed by a controller according to this invention.

FIGS. 3A-3C are timing charts describing the variation of a power current, temperature and voltage of a fuel cell of the power plant during start-up below freezing point.

FIG. 4 is a diagram showing the relationship between the power current and voltage of the fuel cell.

FIG. 5 is a flowchart describing a routine for controlling hydrogen supply to the fuel cell stack performed by the controller in parallel with the defrosting routine.

FIG. 6 is a flowchart describing a routine for defrosting a fuel cell stack performed by a controller according to a second embodiment of this invention.

FIGS. 7A and 7B are timing charts describing the variation of a power current and voltage of a fuel cell of the power plant during start-up below freezing point according to the second embodiment of this invention.

FIG. 8 is a flowchart describing a routine for defrosting a fuel cell stack performed by a controller according to a third embodiment of this invention.

FIG. 9 is a diagram describing the contents of a power current parameter table stored by the controller according to the third embodiment of this invention.

FIG. 10 is a schematic diagram of a fuel cell power plant according to a fourth embodiment of this invention.

FIGS. 11A-11C are timing charts describing the variation of a power current, temperature and voltage of a fuel cell of the power plant during start-up below freezing point according to the fourth embodiment of this invention.

### DESCRIPTION OF THE PREFERRED EMBODIMENTS

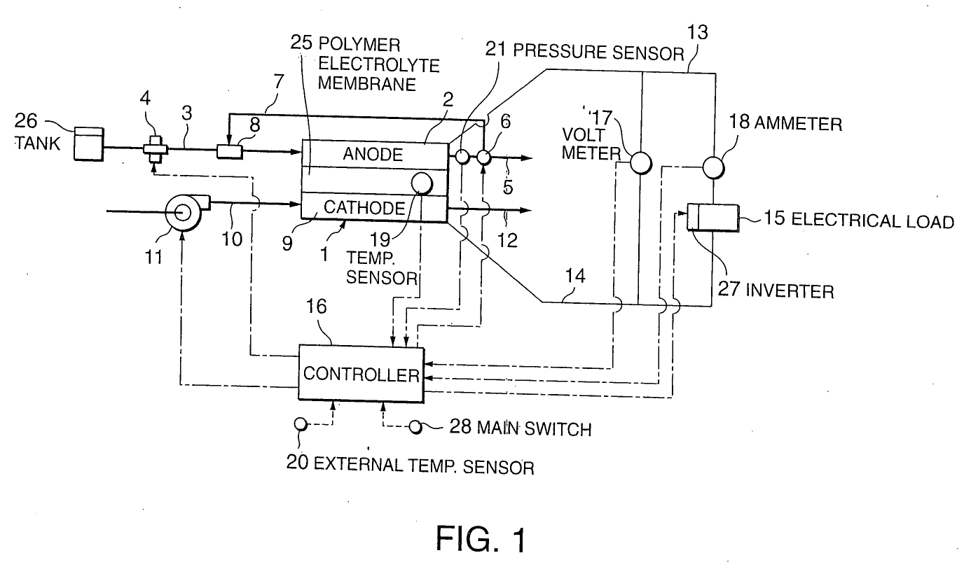

Referring to FIG. 1 of the drawings, a fuel cell power plant for installation in a vehicle comprises a fuel cell stack 1. The fuel cell stack 1 is constituted by a large number of fuel cells connected in series, but for ease of explanation, the fuel cell stack 1 in the drawings is illustrated with a single fuel cell.

A hydrogen supplying passage 3, an air supplying passage 10, a change-over valve 6, and an outlet 12 are connected to the fuel cell stack 1.

Each of the fuel cells of the fuel cell stack 1 comprises a polymer electrolyte membrane 25 interposed between an anode 2 and a cathode 9.

A flow control valve 4 is installed in the hydrogen supplying passage 3 to control hydrogen supply from a hydrogen tank 26 to the anode 2 of each fuel cell. The change-over valve 6 selectively leads anode effluent containing surplus hydrogen not used in the power generation reaction which is discharged from the anode 2 of each fuel cell to a recirculation passage 7 or an outlet 5. The recirculation passage 7 is connected to the hydrogen supplying passage 3 via an ejector pump 8 which suctions anode effluent in the recirculation passage 7 by using a suction force generated by the flow velocity of hydrogen which passes through the ejector pump 8. The outlet 5 opens onto the atmosphere.

The air supplying passage 10 supplies air issued from a blower 11 to the cathode 9 of each fuel cell. The outlet 12 releases cathode effluent containing water vapor generated by the power generation reaction and oxygen not used in the power generation reaction which are discharged from the cathode 9 of each fuel cell into the atmosphere.

Electrical wires 13 and 14 for extracting a direct power current generated by the fuel cell are connected to the fuel cell stack 1. The electrical wires 13 and 14 are connected to an electrical load 15. Here, the electrical load 15 is a generic term comprising an electric motor used for driving the vehicle, the blower 11, various auxiliary machinery such as a pump, a secondary battery and a charging/discharging controller therefor, a vehicle air conditioning device, various lighting, and other electrical components. Power current consumption in the electrical load 15 is controlled via an inverter 27.

Operation of the blower 11, switching of the change-over valve 6, and power current consumption in the electrical load 15 are controlled by a controller 16.

The controller 16 is constituted by a microcomputer comprising a central processing unit (CPU), read only memory (ROM), random access memory (RAM), and an input/output interface (I/O interface). The controller may be constituted by a plurality of microcomputers.

When the fuel cell power plant is to be started up below the temperature at which moisture inside the fuel cell stack 1 freezes, the fuel cell stack 1 must be defrosted. This defrosting can be efficiently realized in a short time period by having the controller 16 appropriately control the power generation load in the fuel cell stack 1 during start-up.

In order to perform this control, the fuel cell power plant comprises a temperature sensor 19 for measuring the temperature of the interior of the fuel cell stack 1, a pressure sensor 21 for detecting the pressure of the anode effluent, a volt meter 17 for detecting the terminal voltage of the fuel cell stack 1, an ammeter 18 for detecting the current consumption of the electrical load 15, an external temperature sensor 20 for detecting the temperature of the atmosphere Ta, and a main switch 28 for commanding start-up of the fuel cell power plant. The detected data of each of these sensors are input into the controller 16 as signals.

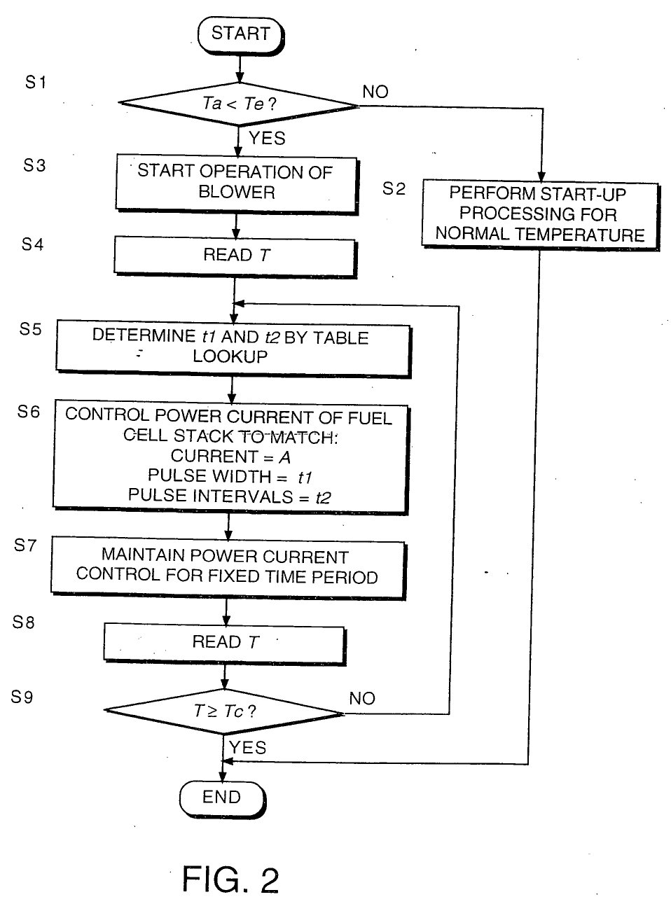

Next, referring to FIG. 2, a routine for defrosting the fuel cell stack 1 which is executed by the controller 16 will be described. The fuel cell power plant is started up when a driver of the vehicle switches on the main switch 28. This routine is executed upon detection of the main switch 28 being switched on.

In a step S1, the controller 16 determines whether or not the fuel cell stack 1 is in a frozen state. This determination is performed in order to judge whether or not there is a likelihood of the supply of air to the cathode being blocked due to the water vapor generated upon power generation turning to water or ice when power generation is performed with the moisture inside the fuel cell stack 1 in a frozen state. This phenomenon becomes more likely to occur as the air temperature falls, and therefore an experiment is performed in advance to determine the air temperature boundary at which this air supply blocking phenomenon appears. The controller 16 determines that the fuel cell stack 1 is in a frozen state when an atmospheric temperature Ta detected by the external temperature sensor 20 is below a predetermined temperature Te set on the basis of this boundary temperature. If it is determined that the fuel cell stack 1 is in a frozen state, the controller 16 executes the processing in steps S3-S9.

If, on the other hand, the atmospheric temperature Ta detected by the external temperature sensor 20 is not below the predetermined temperature Te, the controller 16 executes start-up processing for the fuel cell power plant at a normal temperature in a step S2, and then ends the routine. Start-up processing for the fuel cell power plant at a normal temperature pertains to prior art bearing no relationship to this invention, and hence description thereof has been omitted.

Determination of the frozen state of the fuel cell stack 1 may be performed on the basis of a temperature T of the fuel cell stack 1 detected by the temperature sensor 19 instead of the atmospheric temperature Ta detected by the external temperature sensor 20.

When the fuel cell stack 1 is in a frozen state, the controller 16 first begins to operate the blower 11 in a step S3. As a result, hydrogen and air are supplied respectively to the anode 2 and cathode 9 of the fuel cell stack 1.

Next, in a step S4, the controller 16 reads the temperature Tof the fuel cell stack 1 which is detected by the temperature sensor 19.

Next, in a step S5, the controller 16 retrieves a power current parameter table which is stored in advance in internal memory on the basis of the temperature T of the fuel cell stack 1 to determine a pulse width t1 and pulse interval t2 for power current pulses to be output by the fuel cell stack 1 in accordance with the temperature T TABLE-1 is an example of the power current parameter table.

TABLE 1

| | | | | | | | | |
|---|---|---|---|---|---|---|---|---|
| FUEL CELL | T1 | T2 | T3 | T4 | T5 | T6 | T7 | T8 |
| STACK | | | | | | | | |
| TEMPERATURE | | | | | | | | |
| T (° C.) | | | | | | | | |
| PULSE WIDTH | t11 | t12 | t13 | t14 | t15 | t16 | t17 | t18 |
| PULSE | t21 | t22 | t23 | t24 | t25 | t26 | t27 | t28 |
| INTERVAL | | | | | | | | |

where,
T1 < T2 < . . . < T7 < T8,
t11 < t12 < . . . < t17 < t18; and
t21 > t22 > . . . > t27 > t28.

Referring to TABLE-1, the power current parameter table is characterized in that the pulse width t1 increases and the pulse interval t2 decreases as the temperature T rises. Here, the pulse width t1 indicates the duration of a pulse, and the pulse interval t2 indicates an interval from the halting of pulse current output by the fuel cell stack 1 to the start of the next pulse current output. The controller 16 sets the pulse width t1 and pulse interval t2 in accordance with the temperature T from the power current parameter table. The power current parameter table is set in advance experientially. In TABLE-1, parameters t1i, t2i are set for each of eight temperatures Ti such that i=1-8, but the value of i may be set arbitrarily. It is also possible to create a numerical model based on heat transfer and mass transfer inside the fuel cell stack 1 during start-up at low temperatures such that the pulse width t1 and pulse interval t2 are expressed by an equation which is based on the numerical model.

In a following step S6, the controller 16 controls the inverter 27 such that a power current which matches the determined pulse width t1 and pulse interval t2 is output from the fuel cell stack 1. It should be noted that the height of the pulse which is shown in TABLE-1 corresponds to a power current A. The power current A is a fixed value. The setting method for the power current A will be described hereinafter.

Next, in a step S7, the controller 16 maintains the controlled state of the inverter achieved in the step S6 for a fixed time period.

Next, in a step S8, the controller 16 reads the temperature T of the fuel cell stack 1 detected by the temperature sensor 19 once again.

Next, in a step S9, a determination is made as to whether or not the fuel cell temperature T has reached a defrosting completion temperature Tc of the fuel cell stack 1. The defrosting completion temperature Tc is a temperature at which there is no likelihood of water vapor generated in the cathode 9 turning to water or ice such that the supply of air to the cathode 9 is blocked even when the fuel cell stack 1 begins normal operations.

If, in a step S9, the fuel cell temperature T has not reached the defrosting completion temperature Tc of the fuel cell stack 1, the processing of the steps S5-S9 is repeated until the fuel cell temperature T reaches the defrosting completion temperature Tc. If the fuel cell temperature T has reached the defrosting completion temperature Tc, the controller 16 ends the routine.

Instead of comparing the fuel cell temperature T with the defrosting completion temperature Tc in order to determine the end timing of the defrosting operation, it is also possible to previously determine the defrosting operation period according to the atmospheric temperature Ta in the step S1, and determine if the elapsed time since the start of the defrosting operation has reached the defrosting operation period in the step S9.

Further, it is also possible to monitor the differential pressure between the inlet and outlet of the cathode 9 or monitor the output voltage of the fuel cell stack 1 to determine the end timing of the defrosting operation. When the supply of air to the cathode is blocked by ice in the gas passage, the differential pressure between the inlet and outlet of the cathode increases and the output voltage of the fuel cell stack 1 falls. By monitoring the differential pressure or the output voltage, therefore, it is possible to determine the end timing of the defrosting operation without detecting the fuel cell temperature. In order to precisely determine the end timing of the defrosting operation, however, it may be required to perform the intermittent power generation with a large output current and large pulse width.

In any of the above cases, the temperature sensor 19 can be omitted, so the construction of the fuel cell stack 1 can be simplified.

Following the completion of this defrosting routine, the controller 16 executes control for a normal operation.

The supply of air to the fuel cell stack 1 during this defrosting routine is not performed intermittently, but continuously and at a constant flow rate. Almost none of the air which is supplied to the cathode 9 during a time period corresponding to the aforementioned pulse interval t2 is used in the power generation reaction, but instead functions to cause the moisture generated in the cathode 9 by the power generation reaction to flow downstream and be discharged from the outlet 12 without accumulating in the gas passage and gas diffusion layer which lie adjacent to the cathode 9. The air which is supplied to the cathode 9 has a higher temperature than outside air due to adiabatic compression performed by the blower 11, and is generally above freezing point, and is therefore able to perform such a function.

Even if an electrical load is exerted on the fuel cell stack 1, or in other words if, during the period corresponding to the pulse width t1, moisture generated in the cathode 9 accumulates in the gas passage and gas diffusion layer such that the passage of air to the cathode 9 is blocked, the accumulated moisture is pushed downstream by air when no electrical load is exerted on the fuel cell stack 1, or in other words during the period corresponding to the pulse interval t2, and thus the fuel cell stack 1 is again capable of generating electric power when a subsequent electric load is exerted thereon. This scavenging effect of the in-flowing air becomes more striking as the amount of supplied air increases, and the pulse interval t2 may be decreased as the amount of supplied air increases. The amount of air supplied to the fuel cell stack 1 is preferably at least 1.8 times, and more preferably at least 3 times the amount of air consumed for pulse current power generation.

As described above, it is desirable that the supply of air to the cathode 9 be continuous rather than intermittent.

As regards the supply of hydrogen to the anode 2, meanwhile, hydrogen is also not consumed during the period in which the fuel cell stack 1 does not generate power, and it is therefore desirable that hydrogen be supplied intermittently in accordance with the pulse current. However, it is difficult to supply hydrogen gas intermittently. Hydrogen may be supplied at an average flow rate which is time integrated with the pulse current, but a high degree of precision is required in the flow rate control of the flow control valve 4.

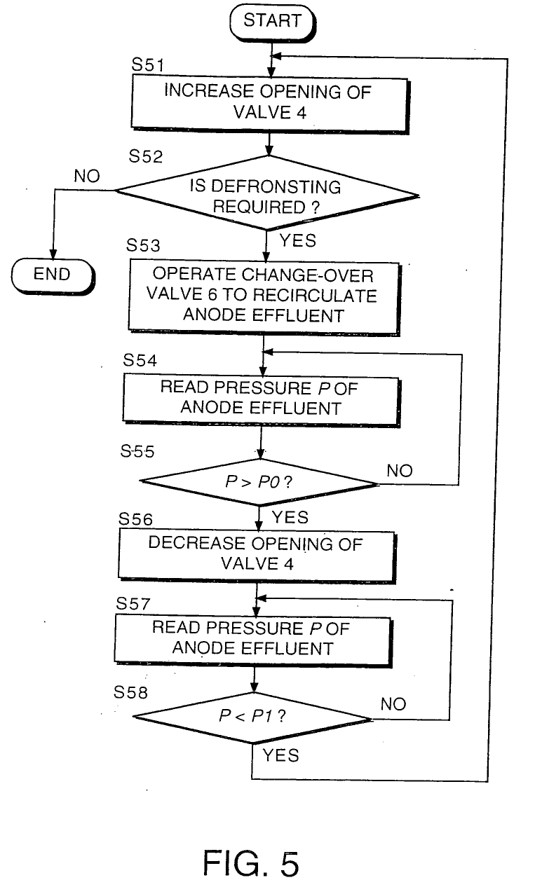

By having the controller 16 execute a hydrogen supply control routine shown in FIG. 5 during the period of defrosting control of the fuel cell stack 1, or in other words in parallel with the defrosting routine shown in FIG. 2, hydrogen supply to the anode 2 is performed in just proportion.

First, in a step S51, the controller 16 increases the opening of the flow control valve 4.

Next, in a step S52, a determination is made as to whether or not the fuel cell stack 1 is in need of defrosting. This is determined by whether or not the steps S3-S9 of the defrosting routine in FIG. 2 are currently being executed.

If the fuel cell stack 1 is in need of defrosting, the controller 16 switches the change-over valve 6 in a step S53 such that the anode effluent of the anode 2 flows into the recirculation passage 7 via the ejector pump 8, thus forming a closed circuit comprising the ejector pump 8, the anode 2, the change-over valve 6, and the recirculation passage 7, through which the anode effluent is recirculated.

Next, in a step S54, the pressure P of the anode effluent detected by the pressure sensor 21 is read.

Next, in a step S55, a determination is made as to whether or not the anode effluent pressure P exceeds a predetermined pressure P0. The controller 16 waits until the anode effluent pressure P reaches the predetermined pressure P0, and when the anode effluent pressure P exceeds the predetermined pressure P0, the controller 16 decreases the opening of the flow control valve 4 in a step S56. During the subsequent period in which the fuel cell stack 1 performs pulse current electric power generation, or in other words in the period corresponding to the pulse width t1, the hydrogen contained in the anode effluent in the closed circuit is consumed in the anode 2. Through this hydrogen consumption, the pressure P of the anode effluent falls.

After decreasing the opening of the flow control valve 4, the controller 16 reads the anode effluent pressure P once again in a step S57, and in a step S58 compares the anode effluent pressure P with a predetermined pressure P1. The predetermined pressure P1 is a value for determining whether or not the opening of the flow control valve 4 should be increased again to increase the supply amount of hydrogen from the tank 26 in order to compensate for a decrease in the hydrogen concentration in the anode effluent.

As can be understood from the above explanation, the predetermined pressure P0 is higher than the predetermined pressure P1.

The controller 16 repeats the processing in the steps S57 and S58 until the anode effluent pressure P falls below the predetermined pressure P1 in the step S57. When the anode effluent pressure P falls below the predetermined pressure P1 in the step S57, the controller 16 returns to the step S51 to increase the opening of the flow control valve 4, and then repeats the processing of the steps S52-S58.

When the defrosting routine of FIG. 2 is complete, the determination result of the step S52 becomes negative, and thus the controller 16 ends the routine.

According to this routine, hydrogen supply to the anode 2 can be performed in just proportion during the defrosting routine of FIG. 2.

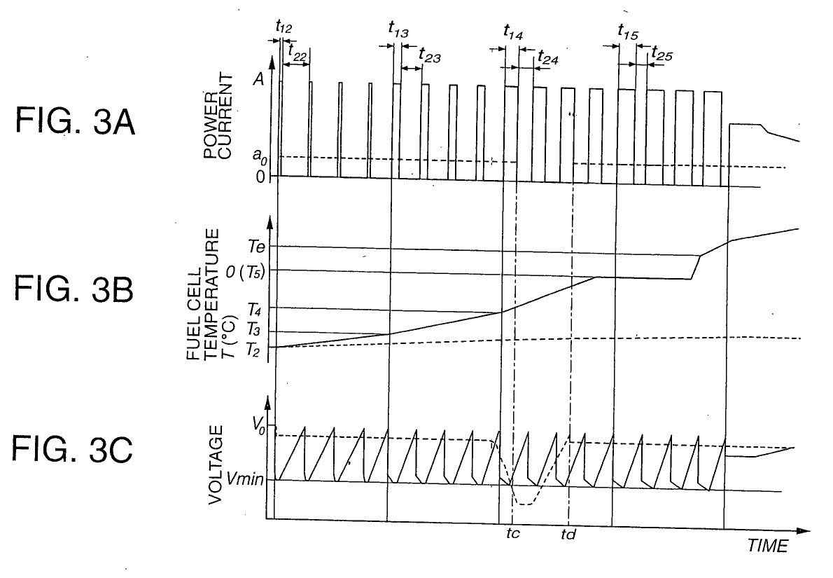

Next, referring to FIGS. 3A-3C, variation in the pulse current, fuel cell temperature T, and power generation voltage when the fuel cell stack 1 is started up from a frozen state by means of the aforementioned control will be described.

The broken lines in the drawing illustrate characteristics when defrosting is performed at a constant power generation current a0 as in the device of JP2000-512068A of the prior art. In this prior art device, a fuel cell stack is started up from a frozen state under a low power current a0 in order to prevent the air supply to the cathode from being blocked by moisture generated in the cathode during power generation in a frozen state. Directly after the beginning of power generation, the terminal voltage falls slightly below an initial voltage V₀, but since the power current a0 is small, the effect thereof is slight. The temperature of the fuel cell stack 1 gradually rises due to the heat generated by the electric power generation of the fuel cell stack 1.

However, when moisture generated in the cathode accumulates in the gas passage and gas diffusion layer such that air is prevented from reaching the cathode, the power generation voltage of the fuel cell stack 1 eventually drops, and when the power generation voltage falls below a minimum value Vmin at a time tc, the fuel cell stack 1 becomes incapable of generating power. This zero current state continues briefly in the fuel cell stack 1. In this state, no power generation reaction takes place, and therefore no water is generated in the cathode. Then, when the moisture accumulated in the gas passage and gas diffusion layer diffuses such that the air supply is able to reach the cathode, the fuel cell stack 1 resumes the power generation reaction, and at a time td the terminal voltage rises above the minimum value Vmin. By suppressing the power generation current of the fuel cell stack 1 in this conventional device to the low power current a0 in this manner, temperature increases in the fuel cell stack 1 are extremely slow, as shown in FIG. 3B, and furthermore, under the low power current a0, a state of power generation incapability may occur as shown in the time period tc−td.

In the fuel cell power plant according to this invention, on the other hand, the controller 16 refers to a table which is stored in internal memory in advance on the basis of the fuel cell temperature T at start-up time to determine the pulse width t1 and pulse interval t2. If, for example, the fuel cell temperature T=T2, the pulse width t1 is set to t12 and the pulse interval t2 is set to t22. The inverter 27 is then controlled such that power generation is performed over a fixed time period according to the set pulse width t12 and pulse interval t22. The power current A at this time greatly exceeds the power current a0 in the conventional device, and hence the drop in voltage accompanying power generation is also large. This large drop in voltage, or in other words low power generation efficiency, causes heat generation such that a larger amount of heat can be generated than in the conventional device. As a result, as shown in FIG. 3B, the temperature T of the fuel cell stack 1 rises rapidly.

Since power generation is performed under a large power current, a large amount of moisture is generated in the cathode 9, and the generated moisture begins to block the supply of air to the cathode 9. However, when the voltage falls to the minimum voltage Vmin, the time period corresponding to the pulse width t12 elapses such that power generation in the fuel cell stack 1 is halted. Meanwhile, air continues to be supplied through the air supply passage 10 and this flow of air reaches the cathode 9 inside the fuel cell stack 1 to scavenge the moisture within the gas passage and gas diffusion layer and discharge this moisture through the outlet 12.

As a result, the fuel cell stack 1 returns to a state of power generation capability. When the pulse interval t22 elapses, power generation by the fuel cell stack 1 resumes. By having the controller 16 control the inverter 27 such that pulse-form current output is performed in this manner, the fuel cell stack 1 is heated by the heat generation which accompanies the output of the large power current A, and by means of the scavenging action during the pulse interval t22, accumulated moisture in the gas passage and gas diffusion layer is removed. Variation in voltage at this time is illustrated in FIG. 3C.

When, as shown in FIG. 3B, the temperature T of the fuel cell stack 1 reaches a predetermined temperature T3 following intermittent power generation by the fuel cell stack 1 over a fixed time period, the controller 16 refers to the table in TABLE-1 once again to set a new pulse width t13 and pulse interval t23. The newly set pulse width t13 is larger than the previous pulse width t12, and the newly set pulse interval t23 is smaller than the previous pulse interval t22. This is due to the fact that, among the moisture generated by the power generation reaction in the cathode 9, a smaller proportion condenses or freezes in the gas passage and gas diffusion layer to block the passage of air into the cathode 9 as the temperature Tof the fuel cell stack 1 rises. Since the amount of moisture which accumulates in the gas passage and gas diffusion layer decreases, the time required for removing the accumulated moisture also decreases.

The controller 16 causes the fuel cell stack 1 to resume intermittent power generation over a fixed time period in accordance with the new pulse width t13 and pulse interval t23. Since the pulse width t13 is larger than the pulse width t12, the amount of heat generated by power generation increases, and as shown in FIG. 3B, the temperature T of the fuel cell stack 1 rises more rapidly. When the temperature T of the fuel cell stack 1 reaches a predetermined temperature T4 after this state has continued for a fixed time period, the controller 16 references the table in TABLE-1 once more to set a new pulse width t14 and pulse interval t24, and then causes the fuel cell stack 1 to resume intermittent power generation over a fixed time period under the new settings.

By performing intermittent power generation while resetting the pulse width t1 and pulse interval t2 on the basis of the temperature T of the fuel cell stack 1 at fixed time intervals in this manner, increases in the temperature T of the fuel cell stack 1 accelerate as shown in FIG. 3B. The reason why increases in the temperature T of the fuel cell stack 1 pause temporarily at zero degrees centigrade, as shown in FIG. 3B, is that heat generated by the power generation reaction in the fuel cell stack 1 is applied to compensate for the latent heat generated when ice in the gas passage and gas diffusion layer as well as ice existing in the other part of the fuel cell stack 1 are melted and therefore does not contribute to the temperature increases in the fuel cell stack 1 as sensible heat.

When the temperature T of the fuel cell stack 1 finally reaches a temperature Te at which normal operations are possible, the shift to a normal operation is determined at the next determination opportunity in the step S9 in FIG. 2, whereupon the controller 16 ends the routine.

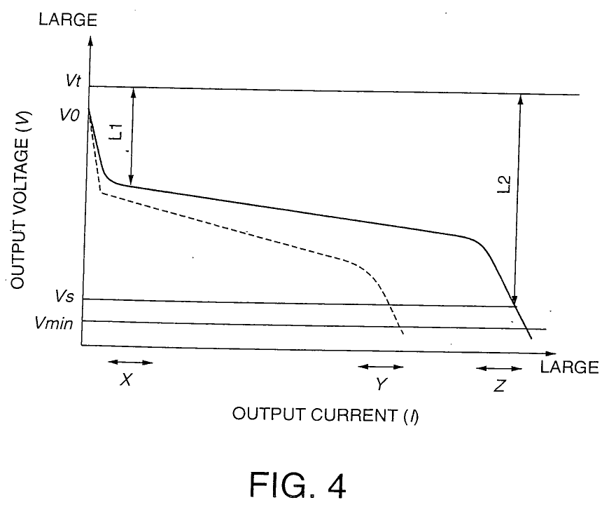

Next, referring to FIG. 4, a method of determining the magnitude of power current A will be described. The solid line curve in this drawing illustrates a typical relationship between output current and terminal voltage in a fuel cell stack, and is known as an I-V curve.

A terminal voltage Vt is a logic value calculated on the basis of an amount of energy discharged by an oxidation reaction of hydrogen. The actual terminal voltage V divided by the logic value Vt is known as the generation efficiency. Of the energy which is discharged in power generation, the energy which is not converted into electric power, that is the energy shown by L1 and L2 in the drawing, is consumed in heat generation.

As the output current/increases, the terminal voltage Vdrops, and even with the same amount of fuel consumption, the amount of energy which is converted to heat increases. Voltage decrease is particularly striking in the high current region Z in the drawing. This is due to the fact that the amount of gas consumed in the reaction increases relative to the diffusion velocity of the reaction gas, i.e., the hydrogen and oxygen, which diffuses on the electrode surface of the fuel cell stack 1, and as a result the velocity of the power generation reaction is dependent on the gas diffusion velocity. A decrease in terminal voltage due to the velocity of gas diffusion is known as a diffusion overpotential.

The output current A of the fuel cell stack 1 is set in the vicinity of the region Z in which the diffusion overpotential becomes dominant. The output current a0 of the fuel cell stack in a frozen state in the conventional device described in JP2000-512068A is set in the vicinity of region X, and hence the amount of generated heat is small.

By setting the output current in the power current region in which the voltage decreases rapidly due to a diffusion overpotential which is based on the characteristic of the fuel cell stack 1, the amount of heat generated during power generation increases such that the temperature T of the fuel cell stack 1 can be raised efficiently.

The relationship between output current I and terminal voltage V is not uniform and differs according to the fuel cell stack. Particularly when activity decreases under low temperatures or when a part of the fuel cell stack is frozen, performance deteriorates, as shown by the broken line curve in the drawing, from the standard characteristic shown by the solid line curve in the drawing. When the performance of the fuel cell stack 1 deteriorates, it is desirable to change the output current A in a frozen state to the vicinity of region Y.

Instead of setting the output current A as a fixed value, the output current A may be altered dynamically using the phenomenon in which the terminal voltage V decreases dramatically in the regions Z and Y. More specifically, the controller 16 controls the power current value such that the voltage falls to a preset minimum voltage Vmin. The minimum voltage Vmin is set at 0.3 to 0.5 volts.

By having the controller 16 control the inverter 27 such that the output current A determined in this manner is realized, generation efficiency can be decreased in respect of the same fuel consumption amount, unlike in a conventional device in which a low power current is steadily extracted from the fuel cell stack, and thus the amount of generated heat can be increased. Further, since the pulse width t1 and pulse interval t2 are reset in accordance with increases in the temperature T of the fuel cell stack 1, accumulated moisture can be removed with certainty from the gas passage and gas diffusion layer so that a power generation reaction can be surely produced in the fuel cell stack 1.

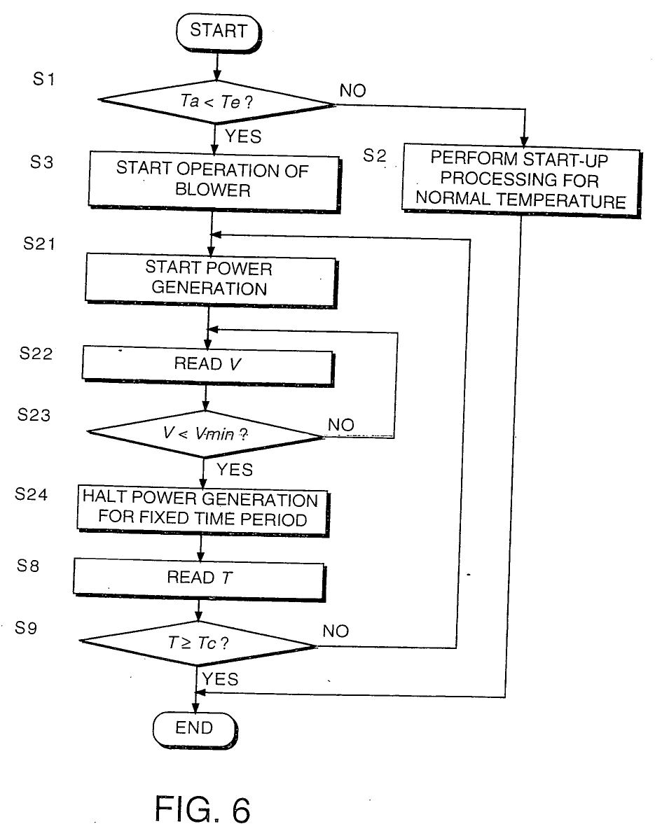

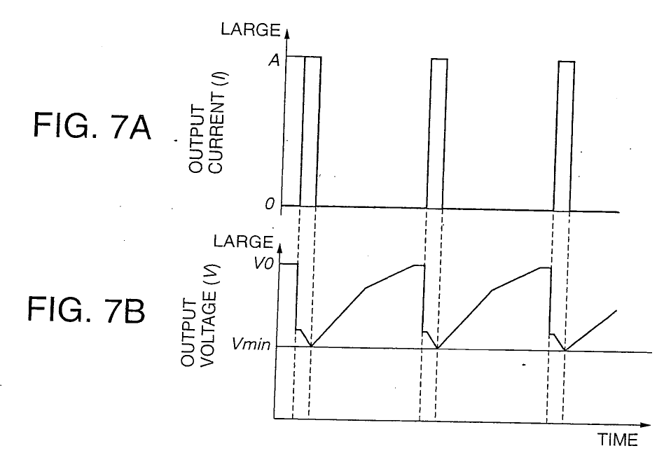

Next, referring to FIG. 6 and FIGS. 7A, 7B, a second embodiment of this invention will be described.

The fuel cell power plant according to this embodiment has an identical hardware constitution to that of the first embodiment, but the logic for controlling the pulse-form output current is different to the first embodiment.

In this embodiment, the controller 16 executes a defrosting routine shown in FIG. 6 in place of the defrosting routine shown in FIG. 2.

The processing in steps S1-S3 and steps S8, S9 is identical to the defrosting routine of FIG. 2.

After beginning operation of the blower 11 in the step S3, the controller 16 controls the inverter 27 in a step S21 to begin power generation in the fuel cell stack 1 under the output current A.

Next, in a step S22, the controller 16 reads the terminal voltage V of the fuel cell stack 1 which is detected by the voltmeter 17.

Next, in a step S23, the controller 16 compares the terminal voltage V with the preset minimum voltage Vmin and repeats the processing in the steps S22 and S23 until the terminal voltage V falls below the minimum voltage Vmin. When the terminal voltage V falls below the minimum voltage Vmin, power generation in the fuel cell stack 1 is halted for a fixed time period in a step S24.

Then, similarly to the defrosting routine in FIG. 2, a determination is made in the steps S8 and S9 as to whether or not the temperature T of the fuel cell stack 1 has reached a temperature Tc at which normal operations are possible. The processing of the step S21 onwards is repeated until the temperature T reaches the normal operating temperature Tc, and when the temperature T reaches the normal operating temperature Tc, the routine ends. Control of the air supply to the cathode 9 is performed in a similar manner to the first embodiment.

Variation in the output current and terminal voltage under the control according to this embodiment is illustrated in FIGS. 7A and 7B. As shown in FIG. 7A, the terminal voltage V of the fuel cell stack 1 declines rapidly as a result of outputting a pulse current corresponding to the output current A, but when moisture accumulates in the gas passage and gas diffusion layer such that the air supply to the cathode 9 is blocked, the terminal voltage V declines further to reach the minimum voltage Vmin.

When the terminal voltage V of the fuel cell stack 1 falls below the minimum voltage Vmin, the controller 16 stops power generation in the fuel cell stack 1 for a fixed time period in a step S24. This stoppage period corresponds to the pulse interval t2 of the first embodiment. Once the fixed time period has elapsed, and if the temperature T of the fuel cell stack 1 has not reached the normal operating temperature Te, power generation in the fuel cell stack 1 is resumed under the output current A.

In this embodiment, power generation is started and stopped on the basis of decreases in the terminal voltage V rather than by setting the pulse width t1, and thus a condition in which power generation is impossible due to the accumulation of moisture in the gas passage and gas diffusion layer can be avoided with certainty such that power generation can be performed throughout the entire period in which power generation is possible. As a result, the temperature of the fuel cell stack 1 can be raised efficiently.

In this embodiment, the power generation stoppage time period of the step S24 is set at a fixed value, but by resuming power generation when the terminal voltage V of the fuel cell stack 1 returns to the initial voltage V₀, the temperature of the fuel cell stack 1 can be raised even more efficiently.

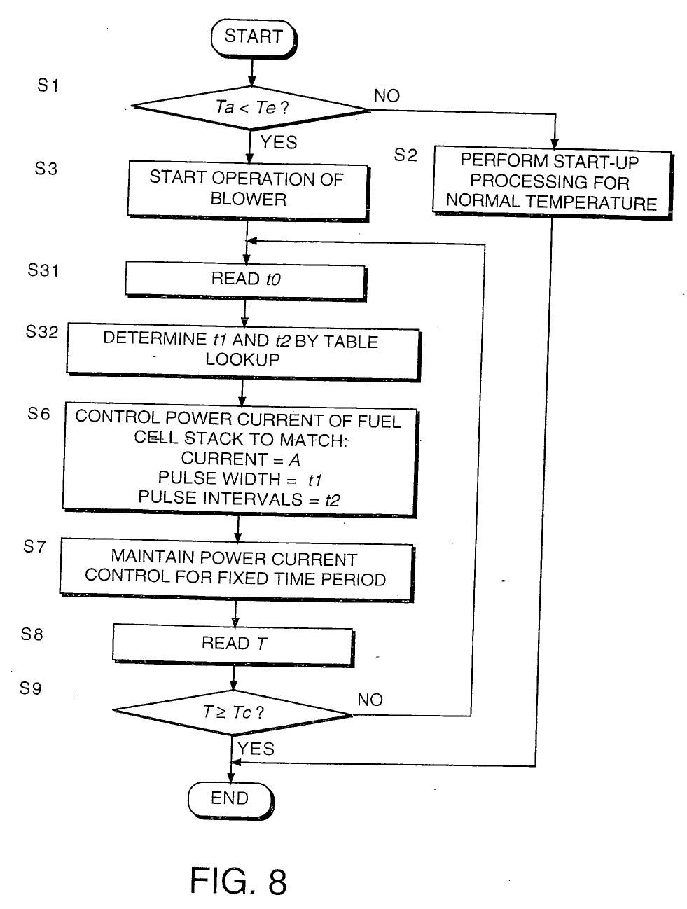

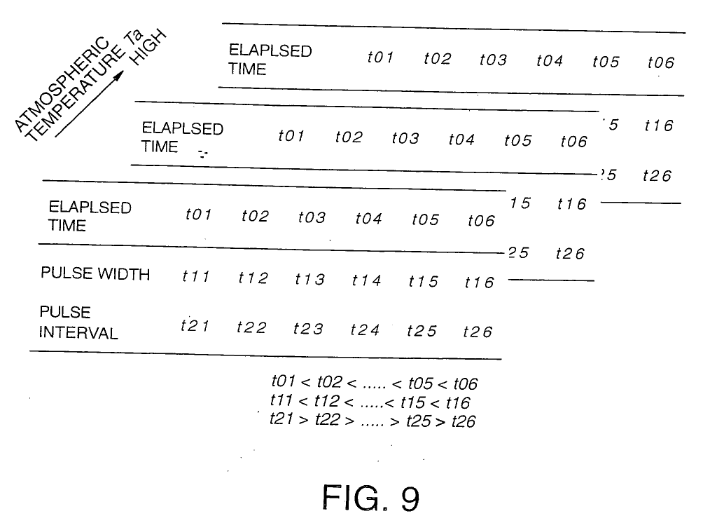

Next, referring to FIGS. 8 and 9, a third embodiment of this invention will be described.

The hardware constitution of the fuel cell power plant in this embodiment is identical to that of the first embodiment, and only the method for setting the pulse width t1 and pulse interval t2 differs from the first embodiment. More specifically, the controller 16 executes a defrosting routine shown in FIG. 8 in place of the defrosting routine in FIG. 2.

Referring to FIG. 8, in this routine steps S31 and S32 are provided in place of the steps S4 and S5 of the defrosting routine in FIG. 2. All other steps are identical to those in the routine in FIG. 2. The controller 16 is installed with a timer for counting elapsed time after the main switch is switched on by the driver. The elapsed time after the main switch is switched on is equal to the elapsed time following the beginning of defrosting of the fuel cell stack 1.

In the step S31, the controller 16 reads the elapsed time t0 after the main switch is switched on. Next, in the step S32, a table having a content as shown in FIG. 9 which is stored in memory in advance is referred to on the basis of the elapsed time t0 and the atmospheric temperature Ta in order to determine a corresponding pulse width t1 and pulse interval t2.

Referring to FIG. 9, a plurality of types of table is stored in memory in advance according to the atmospheric temperature Ta, and the controller 16 first retrieves the table corresponding to the atmospheric temperature Ta to determine from the obtained table the pulse width t1 and pulse interval t2 which correspond to the elapsed time t0.

Here, since the elapsed time t0 is equal to the defrosting time of the fuel cell stack 1, the temperature T of the fuel cell stack 1 rises as the elapsed time t0 increases. Hence in the table, the pulse width t1 and pulse interval t2 are set to increase and decrease respectively as the elapsed time t0 increases.

As concerns the atmospheric temperature Ta, meanwhile, the pulse width t1 and pulse interval t2 are set to decrease and increase respectively as the atmospheric temperature Ta falls in respect of an identical elapsed time t0. This is so that power generation obstruction caused by the accumulation of moisture in the gas passage and gas diffusion layer at low temperatures can be avoided. By setting the pulse width t1 and pulse interval t2 in accordance with these two parameters, i.e. the elapsed time t0 and the atmospheric temperature Ta, the amount of heat generation in the fuel cell stack 1 can be increased toward the upper limit, and thus the amount of time required for defrosting can be shortened.

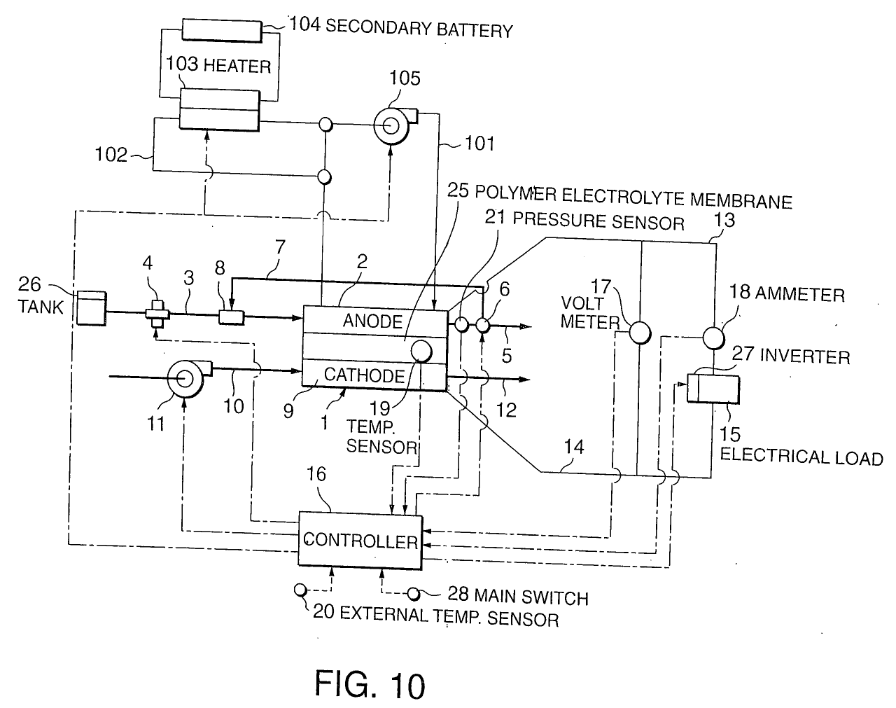

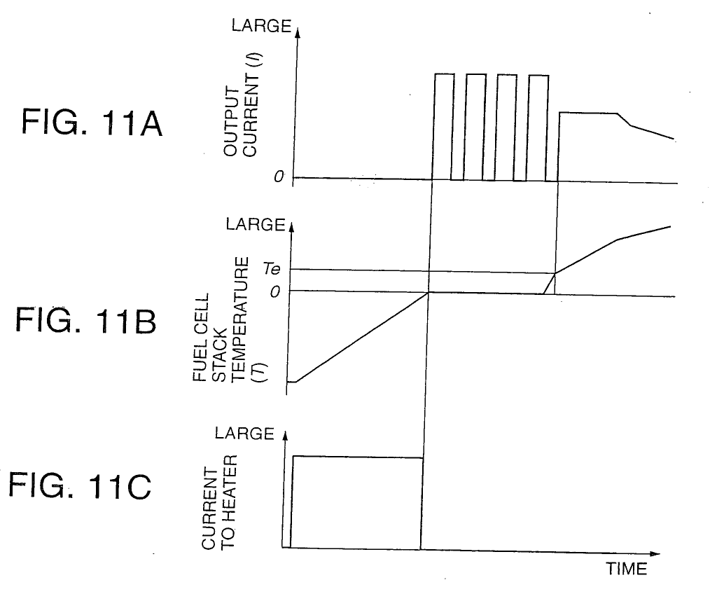

Next, referring to FIG. 10 and FIGS. 11A-11C, a fourth embodiment of this invention will be described.

Referring to FIG. 10, a fuel cell power plant according to this embodiment comprises a cooling passage 101 for cooling the fuel cell stack 1 and an electric heater 103 for heating cooling liquid. The cooling liquid in the cooling passage 101 is pressurized by a pump 105 to be circulated to the fuel cell stack 1. The electric heater 103 is provided on a heating passage 102 which bifurcates from the cooling liquid passage 101. The heater 103 generates heat in response to a power supply from a secondary battery installed in the vehicle to thereby heat the cooling liquid which is led from the cooling passage 101 to the heating passage 102. The cooling liquid is then recirculated to the cooling passage 101 through the heating passage 102.

When the main switch of the vehicle is switched on below freezing point, the controller 16 first energizes the electric heater 103 and operates the pump 105. As a result, the temperature T of the fuel cell stack 1 rises as shown in FIG. 11B.

When the temperature T reaches zero degrees centigrade, the controller 16 stops energizing the electric heater 103 and operating the pump 105. Hydrogen and air are then supplied to the fuel cell stack 1 and the inverter 27 is controlled such the fuel cell stack 1 outputs a pulse-formed current.

The fuel cell stack 1 performs power generation while held at zero degrees centigrade, and the latent heat which accompanies the melting of the interior ice is compensated for by the heat which is generated during power generation. When defrosting is complete and the temperature T of the fuel cell stack 1 reaches the normal operating temperature Te, the controller 16 stops the intermittent power generation of the fuel cell stack 1 and shifts to normal operations. The procedures in any of the first through third embodiments may be applied for this intermittent power generation.

When the fuel cell power plant of this embodiment is started up below freezing point, the fuel cell stack 1 is heated using the electric heater 103 while the temperature T of the fuel cell stack 1 is below freezing point, and once the temperature T of the fuel cell stack 1 has reached freezing point, temperature increases in the fuel cell stack 1 are realized by the heat which is generated during the intermittent power generation of the fuel cell stack 1. When the fuel cell stack 1 is caused to perform power generation below freezing point, the air supply to the cathode 9 becomes more likely to be blocked due to moisture generated in the cathode 9.

Hence in this embodiment, the heat produced by the electric heater 103 and the heat produced by the power generation reaction are separated at a boundary of zero degrees centigrade. The heat energy which is used for heating the fuel cell stack 1 is divided into sensible heat for increasing the temperature of the fuel cell stack 1 and latent heat which is expended in the melting of ice inside the fuel cell stack 1, although generally, latent heat exceeds sensible heat when the fuel cell stack 1 is heated from below freezing point.

The electric heater 103 which is operated by a power supply from the secondary battery is capable of supplying heat regardless of whether the fuel cell stack 1 is in a frozen state or not. Once the temperature T of the fuel cell stack 1 has reached zero degrees centigrade, heating which is equivalent to the latent heat is performed by the heat generated during the intermittent power generation reaction of the fuel cell stack 1, and thus the energy consumption of the secondary battery 104 is minimized. Further, by charging the secondary battery 104 by means of intermittent power generation, the charge amount of the secondary battery 104 can be increased or a driving power can be supplied to auxiliary machinery.

A large amount of electrical energy must be consumed to increase the temperature T of the fuel cell stack 1 to the normal operating temperature Te using the electric heater 103 alone, but if the electric heater 103 is used only to heat the fuel cell stack 1 to zero degrees centigrade, the power consumption of the electric heater 103 is greatly suppressed.

Hence according to this embodiment, normal operations can be started in a shorter amount of time than when the fuel cell stack 1 is warmed to a state in which normal operations are possible by defrosting the frozen moisture therein using only the electric heater 103 or only the power generation reaction of the fuel cell stack 1.

Although the boundary temperature is set equal to zero degrees centigrade in this embodiment, the temperature boundary at which the air supply blocking phenomenon appears is not necessarily zero degrees centigrade. The real temperature boundary is different depending on thermal capacity of fuel cells, temperature and thermal capacity of piping around the fuel cells, temperature of gas provided to the fuel cells, etc. So the boundary temperature is preferably determined through experiment.

The contents of Tokugan 2002-185889, with a filing date of Jun. 26, 2002 in Japan, are hereby incorporated by reference.

Although the invention has been described above by reference to certain embodiments of the invention, the invention is not limited to the embodiments described above. Modifications and variations of the embodiments described above will occur to those skilled in the art, in light of the above teachings.

### INDUSTRIAL FIELD OF APPLICATION

According to this invention as described above, by performing power generation intermittently when a fuel cell stack in a frozen state is defrosted by means of fuel cell power generation, moisture which is generated in the cathode during the power generation is scavenged by oxygen supplied while the power generation is halted. As a result, the supply of oxygen to the cathode is not blocked by the accumulated moisture and power generation can be performed by the fuel cell stack under a large power current even when frozen. Accordingly, when this invention is applied to a fuel cell power plant for driving a vehicle, a frozen fuel cell stack can be warmed in a short period of time without receiving an external energy supply.

The embodiments of this invention in which an exclusive property or privilege is claimed are defined as follows:

1. A fuel cell power plant comprising:
a fuel cell stack comprising fuel cells which generate electric power under a supply of hydrogen and oxygen;
a mechanism which supplies oxygen to the fuel cell stack;
a sensor which detects a parameter for determining if moisture in the fuel cell stack is frozen; and
a controller functioning to:
determine if the moisture in the fuel cell stack is frozen based on the parameter; and
cause the fuel cell stack to perform intermittent electric power generation when the moisture in the fuel cell stack is frozen.

2. The fuel cell power plant as defined in claim 1, wherein the controller further functions to cause oxygen supplying mechanism to continuously supply oxygen to the fuel cell stack when causing the fuel cell stack to perform intermittent electric power generation.

3. The fuel cell power plant as defined in claim 1, wherein the fuel cell stack generates electric power in response to a power requirement, the power plant further comprises a mechanism which regulates the power requirement, and the controller further functions to control the regulating mechanism, when the moisture in the fuel cell stack is frozen, to cause the fuel cell stack to perform the intermittent electric power generation.

4. The fuel cell power plant as defined in claim 3, wherein the fuel cell stack is electrically connected to an electrical load, and the regulating mechanism comprises an inverter which regulates power supply to the electrical load from the fuel cell stack.

5. The fuel cell power plant as defined in claim 4, 3, wherein the controller further functions to control the regulating mechanism to cause an output current of the intermittent electric power generation by the fuel cell stack to coincide with a current at which a decrease in an output voltage of the fuel cell stack occurs due to a diffusion overpotential.

6. The fuel cell stack as defined in claim 4 1, wherein the parameter is one of a temperature of the fuel cell stack and an atmospheric temperature.

7. The fuel cell power plant as defined in claim 1, wherein each of the fuel cells comprises an anode to which hydrogen is supplied and a cathode to which oxygen is supplied, the oxygen supplying mechanism is arranged to supply oxygen to the cathode, and the controller further functions to cause the oxygen supply mechanism, when the fuel cell stack performs the intermittent electric power generation, to increase an oxygen supply amount to the cathode to not less than 1.8 times of an amount which is required for power generation.

8. The fuel cell power plant as defined in claim 1, wherein the power plant further comprises a switch which starts an operation of the power plant, and the controller further functions to determine if the moisture in the fuel cell stack is frozen immediately after the switch is turned on.

9. The fuel cell power plant as defined in claim 1, wherein the power plant further comprises a sensor which detects a temperature of the fuel cell stack, the intermittent electric power generation comprises an output of electric current in the form of pulses, and the controller further functions to vary the width and the interval of the pulses according to the temperature of the fuel cell stack.

10. The fuel cell power plant as defined in claim 9, wherein the controller further functions to increase the width of the pulses as the temperature of the fuel cell stack increases.

11. The fuel cell power plant as defined in claim 9, wherein the controller further functions to decrease the interval of the pulses as the temperature of the fuel cell stack increases.

12. The fuel cell power plant as defined in claim 1, wherein the power plant further comprises a volt meter which detects an output voltage of the fuel cell stack, the controller further functions to cause the fuel cell stack to perform the intermittent electric power generation by causing the fuel cell stack to stop electric power generation, after causing the fuel cell stack to start electric power generation, at a point where the output voltage of the fuel cell stack falls below a predetermined voltage, and to restart electric power generation when a predetermined time has elapsed after electric power generation was stopped.

13. The fuel cell power plant as defined in claim 1, wherein the power plant further comprises a switch which starts an operation of the power plant, the intermittent electric power generation comprises an output of electric current in the form of pulses, and the controller further functions to count an elapsed time after the switch is turned on and increase the width of the pulses as the elapsed time increases.

14. The fuel cell power plant as defined in claim 13, wherein the power plant further comprises a sensor which detects an atmospheric temperature, and the controller further functions to decrease the width of the pulses as the atmospheric temperature decreases.

15. The fuel cell power plant as defined in claim 1, wherein the power plant further comprises a switch which starts an operation of the power plant, the intermittent electric power generation comprises an output of electric current in the form of pulses, and the controller further functions to count an elapsed time after the switch is turned on, and decrease the interval of the pulses as the elapsed time increases.

16. The fuel cell power plant as defined in claim 15, wherein the power plant further comprises a sensor which detects an atmospheric temperature, and the controller further functions to increase the interval of the pulses as the atmospheric temperature decreases.

17. The fuel cell power plant as defined in 1, wherein each of the fuel cells comprises an anode to which hydrogen is supplied, the fuel cell power plant further comprises a hydrogen supply valve which regulates hydrogen supply to the anode, a change-over valve which resupplies an anode effluent discharged from the anode to the anode and a sensor which detects the pressure of the anode effluent, and the controller further functions when the moisture in the fuel cell stack is frozen, to cause the change-over valve to recirculate the anode effluent to the anode and to cause the hydrogen supply valve to maintain the pressure of the anode effluent within a predetermined pressure range.

18. The fuel cell power plant as defined in claim 1, wherein the power plant further comprises a heater which heats the fuel cell stack using energy supplied from a source other than the fuel cell stack and a sensor which detects a temperature of the fuel cell stack, and the controller further functions, when the moisture in the fuel cell stack is frozen, to heat the fuel cell stack using the heater while preventing the fuel cell stack from performing power generation when the temperature of the fuel cell stack is lower than a predetermined temperature, and to cause the fuel cell stack to perform the intermittent electric power generation when the temperature of the fuel cell stack has reached the predetermined temperature.

19. A fuel cell power plant comprising:
a fuel cell stack comprising fuel cells which generate electric power under a supply of hydrogen and oxygen;
means for supplying oxygen to the fuel cell stack;
means for detecting a parameter for determining if moisture in the fuel cell stack is frozen;
means for determining if the moisture in the fuel cell stack is frozen based on the parameter; and
means for causing the fuel cell stack to perform intermittent electric power generation when the moisture in the fuel cell stack is frozen.

20. A control method of a fuel cell power plant, the power plant comprising a fuel cell stack comprising fuel cells which generate electric power under a supply of hydrogen and oxygen and a mechanism which supplies oxygen to the fuel cell stack, the method comprising:
detecting a parameter for determining if moisture in the fuel cell stack is frozen;
determining if moisture in the fuel cell stack is frozen based on the parameter; and
causing the fuel cell stack to perform intermittent generation of electric power when the moisture in the fuel cell stack is frozen.
